(19) United States
(12) Patent Application Publication
(10) Pub. No.: US 2008/0026786 A1
(43) Pub. Date: Jan. 31, 2008

(54) METHOD AND PORTABLE ELECTRONIC DEVICE FOR AUTOMATICALLY SWITCHING LOUDSPEAKER OUTPUT

(75) Inventors: Ming-Jen Kuo, Taoyuan (TW); Ko-Yi Yao, Taoyuan (TW)

Correspondence Address: LAW OFFICES OF MIKIO ISHIMARU, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 11/828,852

(22) Filed: Jul. 26, 2007

(30) Foreign Application Priority Data
Jul. 26, 2006 (TW) 095127232

(51) Int. Cl. H04M 1/00

(52) U.S. Cl. 455/550.1

(57) ABSTRACT

The present invention provides a method and a portable electronic device for automatically switching a loudspeaker output, wherein the portable electronic device includes at least a switch unit, a communication unit, a loudspeaker unit and a navigation unit. While reading an activation signal outputted from the navigation unit and an incoming phone call signal from the communication unit, the switch unit connects the loudspeaker unit to the communication unit, and then proceeds to later processes of receiving phone call, so that users do not have to operate manually on the portable electronic device, the loudspeaker unit is capable of automatically outputting the incoming phone ring and communication voice.

### BACKGROUND OF THE INVENTION

1. Field of Invention

This invention relates to a portable electronic device having navigation and communication units, and more particularly, to a method and a portable electronic device for automatically switching the loudspeaker output between a navigation unit and a communication unit.

2. Description of Related Art

Recent technology has brought convenience to our daily life. Because of the convenience, users desire for better and higher quality products. In order to meet the demand and gain public recognition, manufactures are forced for innovation. Take cell phone as an example. Cell phone has become an indispensable product in our life. Its size and portability are attractive to people. With traditional telephone set, it is built purely for information exchange only. User is unable to enjoy multifunction such as music, game, contact storage and alarm, while operating the phone. But with cell phone, user has the luxury of enjoying these additional features while passing information through at the same time.

Other than standard features on the cell phone, many manufactures have developed the ability to receive global positioning system (GPS) satellite signal. Based on the satellite signal, a cell phone is able to position itself and show the detailed map of current location on the cell phone monitor.

Furthermore, based on these information of the cell phone and information of various maps saved in the navigation software program, when these information of the cell phone matches with the information of one of the maps, the cell phone outputs the map information. For examples, the information of one of the maps matches with information of a location of a certain intersection (e.g., longitude and latitude), and matches with a voice of the location information (e.g. a red-light camera ahead), when a position information (e.g., longitude and latitude) produced by the cell phone while checking the location information is close to the location information of the intersection, the cell phone outputs the voice of the location information, thus the cell phone used inside a vehicle is capable of functioning as a satellite navigation device, and it is also capable of warning the cell phone user to drive carefully as well.

When the cell phone is used inside a vehicle as a GPS device, user is able to see maps and routes on the display screen. User is also able to hear verbal instruction from cell phone. However, if there is an incoming call, user has to take the phone off from the holder bracket and receives phone call by pressing receive button. These actions may distract driver's attention and causes possible car accidents.

Hence, it is a priority for the industry to develop a technique that will make driving while operating GPS phone a safety and efficiency experience for users.

### SUMMARY OF THE INVENTION

In view of the disadvantages of current GPS phone, a general objective of invention has been created. It is to provide a method and a portable electronic device for automatically switching a loudspeaker output during an incoming call. The goal of this invention is to eliminate any unnecessary manual actions with in car GPS phone products.

In order to eliminate any manual actions, the present invention provides a method and a portable electronic device for automatically switching a loudspeaker output, wherein a switch unit of the portable electronic device is capable of reading an activation signal outputted from an navigation unit of the portable electronic device, and also capable of reading an incoming phone call signal outputted from a communication unit of the portable electronic device, and then the switch unit connects the loudspeaker unit to the communication unit, so that the loudspeaker unit receives the incoming phone call signal, and then the loudspeaker unit sends an incoming phone ring in response to the received incoming phone call signal, after the incoming phone ring is sent for a preset period of time, the switch unit automatically sends an receiving phone call signal, and then the communication unit transmits a received far-end communication voice to the loudspeaker unit via the switch unit for being output until the communication voice is disconnected, and then the switch unit connects the loudspeaker unit to the navigation unit. In view of the above, users do not have to operate manually on the portable electronic device, the loudspeaker unit is capable of outputting the incoming phone ring and the communication voice automatically, thereby solving the shortcomings of traditional cell phones.

The portable electronic device of the present invention is capable of automatically switching the loudspeaker output. The portable electronic device of the present invention comprises at least a switch unit, a communication unit, a navigation unit and a loudspeaker unit, wherein if the switch unit receives only a navigation signal outputted from the navigation unit, the switch unit connects the loudspeaker unit to the navigation unit, so that the loudspeaker unit receives a navigation voice signal outputted from the navigation unit, and in response to the navigation voice signal, the loudspeaker unit sends a navigation voice; if the switch unit receives an incoming phone call signal outputted from the communication unit and an activation signal outputted from the navigation unit, the switch units connects the loudspeaker unit to the communication unit, so that the loudspeaker unit receives an incoming phone call signal outputted from the communication unit, and in response to the incoming phone call signal, the loudspeaker unit sends an incoming phone ring.

### BRIEF DESCRIPTION OF DRAWINGS

The present invention can be more fully understood by reading the following detailed description of the preferred embodiments, with reference made to the accompanying drawings, wherein:

FIG. 1 is a structural diagram of the present invention; and

FIG. 2 is a procedural flow chart of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

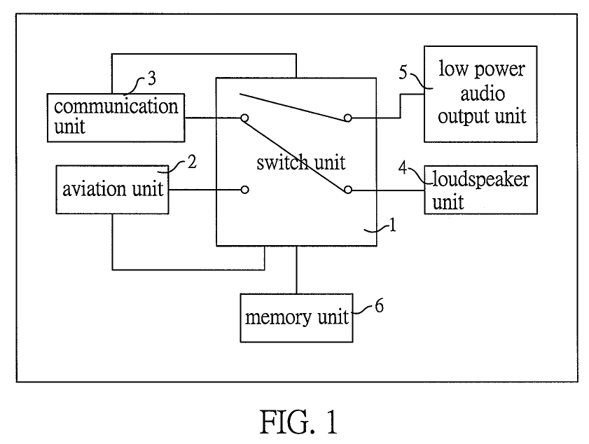

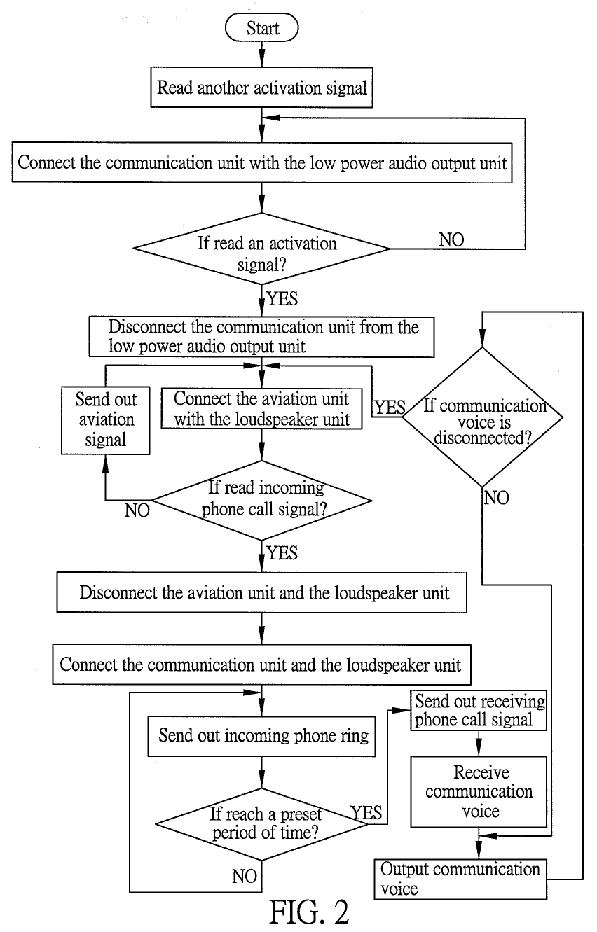

A method for automatically switching a loudspeaker output is provided according to the present invention. Please refer to FIGS. 1 and 2, wherein a switch unit 1 of a portable electronic device is capable of reading an activation signal outputted from a navigation unit 2 of the portable electronic device, and the switch unit 1 is also capable of reading an incoming phone call signal outputted from a communication unit 3 of the portable electronic device. If the switch unit 1 reads the activation signal only, but not an incoming phone call signal outputted from the communication unit 3, the switch unit 1 connects a loudspeaker unit 4 of the portable electronic unit to the navigation unit 2, so that the loudspeaker unit 4 receives a navigation voice signal outputted from the navigation unit 2, and then the loudspeaker unit 4 sends a navigation voice in response to the navigation voice signal. If the switch unit 1 receives the incoming phone call signal and the activation signal, the switch unit 1 first disconnects the navigation unit 2 from the loudspeaker unit 4, and then connects the loudspeaker unit 4 to the communication unit 3, so that the loudspeaker unit 4 first receives the incoming phone call signal and then sends an incoming phone ring in response to the incoming phone call signal. After the incoming phone ring is sent for a preset period of time, the switch unit 1 automatically sends a receiving phone call signal, and then a far-end communication voice received by the communication unit 3 is transmitted via the switch unit 1 to the loudspeaker unit 4 for being output, only until the communication voice is disconnected, the switch unit 1 reconnects the loudspeaker unit 4 to the navigation unit 2 in accordance with the aforementioned processes. Users do not have to manually operate the portable electronic device, and the loudspeaker unit 4 is capable of outputting the incoming phone ring and the incoming communication voice automatically, thereby avoiding the disadvantages of traditional cell phones.

In order to save more energy, after the portable electronic device is activated, the navigation unit 2 is not directly activated, commonly, after the portable electronic device is activated, a GPS receiver disposed in the navigation unit 2 is not provided with power immediately, and before the portable electronic device activates the navigation unit 2, it is not necessary to connect the loudspeaker unit 4 to the communication unit 3, after all, the incoming phone ring and the communication voice outputted from the loudspeaker unit 4 need more power. For these reasons, in one embodiment of the present invention, after the portable electronic device is activated, the switch unit 1 reads only another one activation signal outputted from the navigation unit 2, and in response to the another one activation signal, the switch unit 1 connects the communication unit 3 to a low power audio output unit 5 that is disposed in the portable electronic unit, so that the portable electronic device further saves more power before the portable electronic device uses both the navigation unit 2 and the communication unit 3.

In the embodiment, after the communication unit 3 connects to a low power audio output unit 5 of the portable electronic device, if the switch unit 1 receives the activation signal, the switch unit 1 immediately connects the loudspeaker unit 4 to the navigation unit 2 in response to the activation signal and disconnects the communication unit 3 from the low power audio output unit 5; or, if the switch unit 1 receives the activation signal, the switch unit 1 immediately connects the loudspeaker unit 4 to the navigation unit 2 in response to the activation signal, and, the switch unit 1 disconnects the communication unit 3 from the low power audio output unit 5 after receiving the incoming phone call signal so as to connect the loudspeaker unit 4 to the communication unit 3.

In the embodiment, the navigation unit 2 can include a GPS receiver and a navigation software, wherein after the navigation software is activated, the GPS receiver receives power provided by the portable electronic device, and then the GPS receiver is capable of receiving external global positioning signals continuously and providing the navigation software with these global positioning signals for various navigation processes. For examples, based on these global positioning signals, the navigation software is capable of calculating the longitude/latitude of the position of the portable electronic device, and then based on the calculated longitude/latitude, marking a location flag on a map that is outputted from the navigation software and is displayed on the display screen of the portable electronic device, or outputting a navigation voice signal corresponding to the longitude/latitude. In addition, after the navigation software is activated, the portable electronic device produces an activation flag, and the activation flag is then recorded in a memory unit 6 of the portable electronic device.

In the embodiment, after the GPS receiver receives the power provided by the portable electronic device, the switch unit 1 takes a power signal of power received by a receiving power connector of the GPS receiver as the activation signal, or, when the GPS receiver provides the navigation software with the global positioning signal, the switch unit 1 is capable of receiving the global positioning signal, and then takes the global positioning signal as the activation signal, or, the switch unit 1 is capable of reading the activation flag and then takes the activation flag as the activation signal.

The present invention further provides a portable electronic device for automatically switching a loudspeaker output. The portable electronic device includes a switch unit 1, a communication unit 3, a navigation unit 2 and a loudspeaker unit 4, wherein the communication unit 3 is capable of outputting an incoming phone call signal and a communication voice to the switch unit 1, and the navigation unit 2 is capable of outputting an activation signal and a navigation voice signal to the switch unit 1. When the switch unit 1 receives the incoming phone call signal and the activation signal, the switch unit 1 connects the loudspeaker unit 4 to the communication unit 3, and then the loudspeaker unit 4 receives the incoming phone ring and the communication voice; when the switch unit 1 receives the activation signal only, the switch unit 1 connects the loudspeaker unit 4 to the navigation unit 2, and then the loudspeaker unit 4 receives the navigation voice signal.

In the present invention, if the switch unit 1 receives the incoming phone call signal after receiving the activation signal, the switch unit 1 immediately disconnects the navigation unit 2 from the loudspeaker unit 4, and then the loudspeaker unit 4 is immediately connected to the communication unit 3 via the switch unit 1 and sends the incoming phone ring in response to the incoming phone call signal, thereby reminding user that the portable electronic device is receiving an incoming message.

In the present invention, in order to receive the incoming phone call automatically, after the incoming phone ring is sent for a period of time preset by the portable electronic device, the switch unit 1 of the portable electronic device sends a receiving phone call signal to the communication unit 3, so that the communication unit 3 receives a far-end communication voice and then transmits the communication voice to the loudspeaker unit 4 for being output, and only until the switch unit 1 no longer receives the communication voice, the switch unit 1 reconnects the loudspeaker unit 4 to the navigation unit 2.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A method for automatically switching a loudspeaker output in a portable electronic device, wherein the portable electronic device comprises at least a switch unit, a navigation unit, a communication unit and a loudspeaker unit, the method comprising the steps of:
a) reading an activation signal outputted from the navigation unit and an incoming phone call signal outputted from the communication unit by the switch unit; and
b) connecting the loudspeaker unit to the communication unit by the switch unit.

2. The method for automatically switching a loudspeaker output in a portable electronic device of claim 1, further comprising the steps of:
c) sending a receiving phone call signal by the switch unit after connecting the loudspeaker unit to the communication unit; and
d) transmitting a far-end communication voice through the communication unit and then to the loudspeaker unit via the switch unit.

3. The method for automatically switching a loudspeaker output in a portable electronic device of claim 2, wherein the step of a) further comprises the steps of:
after reading the activation signal outputted from the navigation unit but before reading the incoming phone call signal outputted from the communication unit by the switch unit, connecting the loudspeaker unit to the navigation unit by the switch unit; and
receiving a navigation voice signal outputted from the navigation unit, and sending a navigation voice by the loudspeaker unit in response to the navigation voice signal.

4. The method for automatically switching a loudspeaker output in a portable electronic device of claim 3, wherein the step of a) further comprises the steps of:
when the switch unit of the portable electronic device receives the activation signal and the incoming phone call signal, disconnecting the navigation unit from the loudspeaker unit, and then connecting the loudspeaker unit to the communication unit by the switch unit.

5. The method for automatically switching a loudspeaker output in a portable electronic device of claim 4, wherein as the communication is over, the method further comprises the step of:
e) connecting the loudspeaker unit to the navigation unit by the switch unit.

6. The method for automatically switching a loudspeaker output in a portable electronic device of claim 5, wherein after connecting the loudspeaker unit to the communication unit and before sending a receiving phone call signal by the switch unit, the method further comprises the step of:
b1) receiving the incoming phone call signal, and then outputting an incoming phone ring in response to the incoming phone call signal by the loudspeaker unit.

7. The method for automatically switching a loudspeaker output in a portable electronic device of claim 6, wherein the step of c) is performed once the incoming phone ring is sent from the loudspeaker unit outputs for a preset period of time.

8. The method for automatically switching a loudspeaker output in a portable electronic device of claim 7, wherein the navigation unit comprises at least a GPS receiver and a navigation software and wherein after activating the portable electronic device and before performing the step of a), the method further comprises the step of:
a₀) only reading a further activation signal outputted from the communication unit and connecting the communication unit to a low power audio output unit disposed in the portable electronic device by the switch unit according to the further activation signal.

9. The method for automatically switching a loudspeaker output in a portable electronic device of claim 8, wherein the navigation unit comprises at least a GPS receiver and a navigation software, and the step of a₀) further comprises steps of:
after activating the navigation software, receiving power provided by the portable electronic device by the GPS receiver; and
using a power signal of the power received by a receiving power connector disposed in the GPS receiver as the activation signal for the switch unit.

10. The method for automatically switching a loudspeaker output in a portable electronic device of claim 8, wherein the step a₀) further comprises the steps of:
after activating the navigation software, continuously receiving external global positioning signals by the GPS receiver; and
receiving the global positioning signals as the activation signals by the switch unit.

11. The method for automatically switching a loudspeaker output in a portable electronic device of claim 8, wherein the navigation unit comprises at least a GPS receiver and a navigation software, and the step a₀) further comprises the steps of:
after activating the navigation software, producing an activation flag by the portable electronic device to be recorded in a memory unit of the portable electronic device, and reading the activation flag as the activation signal by the switch unit.

12. The method for automatically switching a loudspeaker output in a portable electronic device of claim 8, wherein after performing the step of a₀) and before performing the step of a), the method further comprises the step of:
if the activation signal is received, immediately connecting the loudspeaker unit to the navigation unit by the switch unit in response to the activation signal, and disconnecting the communication unit from the low power audio output unit.

13. The method for automatically switching a loudspeaker output in a portable electronic device of claim 8, wherein after performing the step of a₀) and before performing the step of a), the method further comprises the steps of:
if the activation signal is received, connecting the loudspeaker unit to the navigation unit by the switch unit in response to the activation signal; and
if the switch unit disconnects the communication unit from the low power audio output unit after receiving the incoming phone call signal, connecting the loudspeaker unit to the communication unit by the switch unit.

14. A portable electronic device for automatically switching a loudspeaker output, comprising:
a loudspeaker unit;
a communication unit for sending an incoming phone call signal and a communication voice;
a navigation unit for sending an activation signal and a navigation voice signal; and
a switch unit for connecting the loudspeaker unit to the navigation unit while receiving only the activation signal so that the navigation voice signal is received by the loudspeaker unit, and for connecting the loudspeaker unit to the communication unit while receiving the incoming phone call signal and the activation signal so that the incoming phone call signal and the communication voice are received by the loudspeaker unit.

15. The portable electronic device for automatically switching a loudspeaker output of claim 14, wherein after the loudspeaker unit sends an incoming phone ring in response to the incoming phone call signal for a period of time preset by the portable electronic device, the switch unit sends a receiving phone call signal to the communication unit, and the communication unit receives a far-end communication voice and transmits the far-end communication voice to the loudspeaker unit to be output.

16. The portable electronic device for automatically switching a loudspeaker output of claim 15, wherein the switch unit on longer receives the communication voice, and the switch unit connects the loudspeaker unit to the navigation unit.

17. The portable electronic device for automatically switching a loudspeaker output of claim 15, further comprising a low power audio output unit, wherein when the switch unit receives only a further activation signal outputted from the communication unit, the switch unit connects the low power audio output unit to the communication unit.
